(19) United States
(12) Patent Application Publication
(10) Pub. No.: US 2026/0100985 A1
(43) Pub. Date: Apr. 9, 2026

(54) METHOD AND COMMUNICATION CONTROL DEVICE FOR DATA TRANSMISSION IN A VEHICLE

(71) Applicant: MERCEDES-BENZ GROUP AG, Stuttgart (DE)

(72) Inventors: Jörg ECHARD, Sindelfingen (DE); Martin KEPPLER, Oberreichenbach (DE)

(21) Appl. No.: 19/115,325

(22) PCT Filed: Aug. 30, 2023
(86) PCT No.: PCT/EP2023/073826

§ 371 Date: Mar. 26, 2025

(30) Foreign Application Priority Data
Sep. 27, 2022 (DE) 10 2022 003 531.6

(51) Int. Cl. H04L 67/12; G07B 15/06

(52) U.S. Cl. CPC H04L 67/12; G07B 15/06

(57) ABSTRACT

Data packets provided by at least one stationary data transmission device in a vehicle are transmitted via at least one channel. The data packets are received by a communication control device via a communication module configured for reception via the at least one channel, and are cached in a storage device. An allowable delivery latency is determined for each data packet and the data packets are transmitted in ascending order of the allowable delivery latencies to at least one further component of the vehicle via at least one data transmission path having a transmission rate that is less than the maximum transmission rate of the at least one channel.

### BACKGROUND AND SUMMARY OF THE INVENTION

Exemplary embodiments of the invention relate to a method for transmitting data packets in a vehicle, a communication control device for a vehicle, and an arrangement of components in a vehicle.

Stationary data transmission devices, installed along transport routes, for example, are known for different channels, for example for transmission of data via ultra-short wave (USW), microwave, or infrared light. By means of these data transmission devices, data packets can be sent to moving vehicles and/or data packets sent by these vehicles can be received. Data packets of such type can comprise, for example, information about traffic flow, traffic congestion, restricted usability of transport routes depending on the vehicle weight, vehicle type, vehicle height or similar parameters, or applicable road tolls (toll charges).

Furthermore, for example, distributed data exchange systems for vehicles that have a geographically stationary cache for caching data are known from the publication DE 10 2018 221 933 A1. A distributed data exchange system also has a sending device in a first vehicle for sending the data to be cached to the geographically stationary cache via a first short-range interface, a receiving device in a second vehicle that drives past the cache for receiving the cached data from the geographically stationary cache via a second short-range interface, and a processor connected to the cache. The processor is set up to process the data sent to the cache, to create environment model data, to write environment model data into the cache, and to send said environment model data to the second vehicle.

The document WO 2021/043841 A1 describes an apparatus for controlling access to a wireless communication network with a time-division multiplexing method. The apparatus comprises a timeslot allocation module that assigns a timeslot for the data transmission from a first node to a second node, and a validation module that validates a data packet before transmission from the first node to the second node based on a latency requirement for the data packet and based on an expected latency of the data packet depending on the time of the assigned timeslot. The validation module is provided for distinguishing between data packets to be transmitted and data packets not to be transmitted. The apparatus also comprises a time control module that schedules a data packet to be transmitted in the timeslot provided for transmission from the first to the second node.

The data received by a moving vehicle via a data transmission device and/or from a stationary cache is subject to very different requirements with regard to a maximum allowable latency (i.e., a time lag until processing and/or display in the respective vehicle). Some information, for example, general information about the road conditions or traffic congestion some distance away, is not or not very time-critical. Other information, for example warning messages about catastrophic events, such as tsunamis or earthquakes, but also payment requests related to a toll requirement for the road use (toll), has to be processed and/or displayed immediately or within a very short time frame.

Data packets of such type usually only have a small volume, which is typically between 10 kilobytes and 100 kilobytes. However, a channel for data transmission has to have a transmission rate between the stationary data transmission device and the vehicle that ensures the complete receipt of all useful data and all meta and security data, required for securing the transmission protocol, within a time window that can be severely limited by the maximum movement speed of the vehicle and the minimum range of the data transmission device.

The required transmission rate resulting therefrom of such a channel exceeds the bandwidth or transmission rate typically provided for data transmission between components within a vehicle, often significantly, sometimes by one or many orders of magnitude.

Therefore, it was necessary to provide communication control devices designed to receive data via such channels with special data transmission interfaces (also referred to as gateways in the following), which enable a higher data transmission rate than typically provided in a vehicle. On the one hand, such special gateways lead to higher production costs, in particular since they are not only to be provided for a communication control device, but also for other components that are to process and/or display data received via such a channel.

Furthermore, data transmission paths with higher bandwidths are more sensitive to interference, in particular electromagnetic interference, and thus place higher requirements on the cable routing and the assembly.

There is therefore a need for a method with which data packets received via a channel with a high transmission rate can be distributed within the vehicle via data transmission paths that have a significantly lower transmission rate compared to the channel, without thereby compromising requirements for a maximum allowable latency in the delivery of such data packets.

According to a first aspect of the invention, in a method for transmitting data packets within a vehicle, which are provided by at least one stationary data transmission device via at least one channel, the data packets are received by a communication control device of the vehicle by means of a communication module set up for reception via the at least one channel and are cached in a storage device. In one embodiment, data packets are provided with a time stamp when they are cached, which specifies the time of receipt by the communication module.

An allowable delivery latency is determined for each data packet, which specifies within which time frame from receipt of the data packet the latter is to be processed and/or presented, for example is to be displayed, in the vehicle by the communication module.

For example, a comparatively great delivery latency is assigned to data packets that indicate traffic congestion still at some distance from the vehicle. In contrast, a comparatively low delivery latency is assigned to data packets that indicate a toll charge to be paid to access a toll road. Similarly, a comparatively low delivery latency is assigned to data packets that indicate a warning message for a tsunami, an earthquake, or a fire on an embankment along the road ahead.

The data packets are transmitted in an order to at least one further component of the vehicle via at least one data transmission path, which is set up to exchange data with the communication control device, and the transmission rate of which is less than the maximum transmission rate of the at least one channel for receiving data from the at least one stationary data transmission device.

The order for transmission of the data packets is determined such that the allowable delivery latency of each data packet is adhered to.

For example, the latest possible allowable delivery time for a data packet can be determined by means of the delivery latency from the time stamp of the receipt of this data packet by the communication module, i.e., the time up to which this data packet has to be transmitted via the data transmission path to the at least one further component. Thus, all cached data packets can be sorted according to their latest possible allowable delivery times, beginning with the earliest (i.e., the most pertinent) allowable delivery time, and are transmitted in the order of this list. In this manner, given a sufficient transmission rate of the data transmission path, a correctly timed delivery of all data packets can be guaranteed.

In other words: the data packets received by the communication control device are cached and are prioritized for forwarding via the data transmission path in such a way that data packets to be delivered urgently obtain a high priority and less urgent data packets have a lower priority.

In this manner, the data, which is received from the channel within the transmission time window delimited by the minimum range of the stationary data transmission device and the maximum speed of a vehicle, can be distributed over a comparatively longer time frame to further components in the vehicle, without data packets getting lost or requirements with regard to the delivery latency being breached in the process.

Therefore, it is possible to use cost-effective gateways with a lower transmission rate for the at least one data transmission path within the vehicle, as is possible in the prior art. In particular, particularly special gateways designed for particularly high transmission rates, for example Universal Serial Bus (USB) interfaces or Controller Area Network Flexible Data rate (CAN-FD) gateways, can be omitted.

Additionally, the at least one data transmission path is made more resistant to interference. Furthermore, the requirements for the cable routing and the assembly of such data transmission paths in the vehicle can be eased.

In one embodiment of the method, the data that is transmitted from the communication control device via the at least one data transmission path with a lower transmission rate than the maximum transmission rate of the at least one channel, at least partially comprises toll payment information.

By assigning data packets comprising such toll payment information a low delivery latency and correspondingly a high priority for transmission to the at least one other component in the vehicle, this data is preferably displayed and/or processed. Therefore, despite the comparatively limited (compared to the channel) transmission rate of the communication control device, proper processing of the payment transaction for a toll is guaranteed.

In a further embodiment of the method, the data that is transmitted from the communication control device via the at least one data transmission path with a lower transmission rate than the maximum transmission rate of the at least one channel, at least partially comprises urgent warning messages.

By assigning data packets comprising such urgent warning messages a low delivery latency and correspondingly a high priority for transmission to the at least one other component in the vehicle, these warning messages are preferably displayed and/or processed. Therefore, despite the comparatively limited (compared to the channel) transmission rate of the communication control device, it is ensured that vehicle occupants correctly and securely receive any imminent urgent warning messages.

According to a second aspect of the invention, a communication control device for a vehicle comprises a communication module having a transceiver device set up to receive data packets from a stationary data transmission device via at least one channel. According to the invention, the communication control device also comprises a storage device for caching data packets, a computing unit, and at least one gateway set up to connect to in each case one data transmission path, the transmission rate of which is less than the maximum transmission rate of the at least one channel, wherein the communication control device is set up to carry out the method, described according to the first aspect of the invention, for transmitting data packets within a vehicle. In particular, the communication control device is set up to prioritize and the storage device is set up to cache data packets received via the channel.

By selecting the transmission rate of the at least one gateway to be lower than the transmission rate of the channel, simpler and also less interference-prone assemblies can be used for the construction of such a communication control unit according to the invention, in particular gateways that are widely used in automotive manufacturing and are available at low cost. The further advantages of the communication control device according to the invention correspond to those of the method according to the invention for transmitting data packets within a vehicle.

In one embodiment, the at least one gateway is designed as a controller area network (CAN) gateway having a transmission rate that is lower than the maximum transmission rate of the at least one channel. Such CAN gateways are particularly widespread in automotive manufacturing and are cost-effective.

According to a third aspect of the invention, an arrangement of components, which for example could be designed as a control device, as infotainment components, or as a display and operating device, comprises at least one component designed as a communication control device according to the second aspect of the invention, and is set up to receive data packets from a stationary data transmission device via at least one channel and is connected to at least one further component via a data transmission path, the transmission rate of which is less than the maximum transmission rate of the at least one channel.

The advantages of such an arrangement correspond to the advantages of the method for transmitting data packets within a vehicle according to the first aspect of the invention and to the advantages of the communication control device according to the second aspect of the invention.

In one embodiment, at least one further component connected to the communication control device is designed as an infotainment main unit and is set up to determine a route for the vehicle.

The invention is based on the understanding that such an infotainment main unit only rarely receives urgent data packets with short delivery latency in its typical operating mode, for example warning messages about natural catastrophes or toll payment information, however it receives less time-critical or non-time-critical data packets with high delivery latency comparatively more frequently but still at sufficiently long intervals.

By prioritizing data packets according to their maximum allowable delivery latency using the method according to the invention and caching them in a storage device until they are transmitted via the at least one data transmission path, the burst-like data transmission with a high data transmission rate can be stabilized on the channel. This enables data transmission at a significantly lower data transmission rate without compromising the security or reliability of the infotainment main unit. Further advantages of such an embodiment correspond to the advantages of the method for transmitting data packets within a vehicle according to the first aspect of the invention and to the advantages of the communication control device according to the second aspect of the invention.

### BRIEF DESCRIPTION OF THE SOLE DRAWING

Exemplary embodiments of the invention are explained in more detail in the following using the drawing.

Here:

The sole drawing schematically shows a stationary data transmission device and a vehicle having a communication control device.

Parts corresponding to each other are provided with the same reference signs in all the figures.

### DETAILED DESCRIPTION

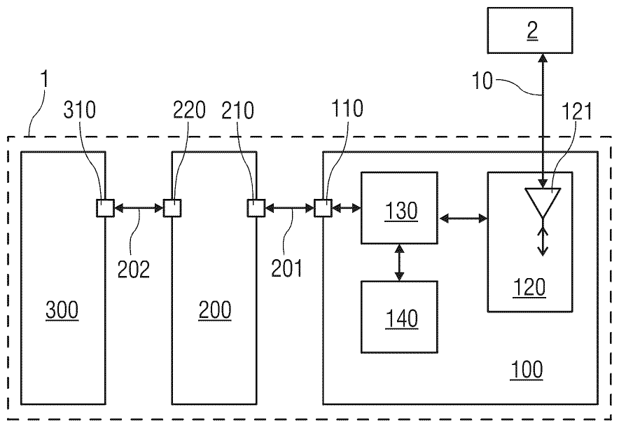

FIG. 1 schematically shows a moving vehicle 1 and a stationary data transmission device 2. The vehicle 1 comprises a communication control device 100, an infotainment head unit 200, and further electric and/or electronic components, which are compiled purely schematically in a vehicle electronics unit 300 in FIG. 1. The infotainment head unit 200, which in the following is also referred to as a head unit 200, is connected to the communication control device 100 and to the vehicle electronics 300 using a respective bidirectional data transmission path 201, 202 for exchanging data and/or control instructions, respectively.

The vehicle 1 and the data transmission device 2 are set up to exchange data via a channel 10.

The channel 10 can, for example, be designed as a unidirectional frequency-modulated channel 10, via which data packets are sent from a data transmission device 2, preferably designed as a terrestrial transmitting station, and therefore are provided in the manner of a radio signal for receipt by a plurality of vehicles 1. Data packets of up to 50 kilobytes can be transmitted over such a frequency-modulated channel 10 at a typical carrier frequency of between 76 MHz and 90 MHz over a typical radius of around 10 km to 50 km at a data transmission rate of around 16 kilobits per second.

In another embodiment, the channel 10 can also be designed as a microwave channel 10, in which data packets of up to 25 kilobytes are transmitted over a carrier frequency of typically 5.8 GHz with a data transmission rate of approx. 4 megabits per second. In such an embodiment, the data transmission station 2 is designed as a stationary microwave beacon which typically has a range of up to 20 meters and is typically installed along transport routes with high volumes of traffic, such as motorways and dual carriageways.

In a further embodiment, the channel 10 can also be designed as an infrared channel 10, in which data packets of up to 10 kilobytes are transmitted via a visual connection between the vehicle 1 and a data transmission station 2 designed as an infrared beacon. Such infrared beacons typically have a range of up to 3.5 meters and are set up for data transmission rates of up to 1 megabit per second from the infrared beacon to the vehicle 1 (downlink) and of up to 64 kilobits per second from the vehicle 1 to the infrared beacon (uplink) and are installed along transport routes with normal or low volumes of traffic.

In the sole figure, only one channel 10 is represented for the sake of simplicity, however a vehicle 1 is typically set up to exchange data with different stationary data transmission devices 2, which can take place via multiple differently designed channels 10.

The infotainment main unit or head unit 200 provided in the vehicle processes data transmitted via the channel 10 and/or provides such data for transmission.

For example, the head unit 200 is set up, among other things, for routing, i.e., for calculating a route of the vehicle 1 using position data and map data. Traffic data can be taken into account for such routing, which is provided via at least one channel 10. Traffic data can comprise information about traffic flow and/or traffic management, for example about current closures, congestion, or other restrictions along transport routes which are relevant for the routing. The display and processing of traffic data by the head unit 200 is generally not time-critical.

Furthermore, a head unit 200 can display important information for the vehicle occupants, for example warnings about storms or catastrophe situations along the route, which is similarly provided via one or more channels 10 from stationary data transmission devices 2.

Furthermore, a head unit 200 can display and/or process important information that relates to a specific traffic route currently being travelled by the vehicle 1, for example information about a toll charge (i.e., information about an amount of money to be paid directly for the use of a road section), information about a height limit or a limited tonnage, for example when travelling on a ferry, about a tunnel, a bridge, or another traffic structure.

Such information, which is listed here only by way of example and by no means exhaustively, can also be provided via stationary data transmission devices 2. Such information may require an immediate reaction by the head unit 200 or another component of the vehicle electronics 300 and/or by a vehicle occupant of the vehicle 1.

The invention is thus based on the understanding that different data received from a vehicle 1 via one or more channels 10 is to be processed with different temporal urgency or priority. Some of this data is associated with hard real-time requirements and must be processed and/or displayed to a vehicle occupant within a predetermined time period or allowable delivery latency, calculated from receipt by the vehicle 1. Other data is connected to soft real-time requirements, i.e., it has to be processed and/or displayed as a statistical average within a specific time frame, however this time frame can also be exceeded in isolated circumstances. Further data is to be processed and/or displayed without particular time requirements.

Based on this finding, the object of the invention is to organize the transmission, storage and processing of such data received via one or more channels 10 in the vehicle 1 in such a way that all time requirements are met with particularly little technical effort and no data is lost.

For this purpose, a communication module 120 with at least one transceiver device 121 is provided to exchange data via the at least one channel 10 in the communication control device 100. For example, a first transceiver device 121 can be set up as an ultra-short-wave receiver for receiving data via a frequency-modulated channel 10, a second transceiver device 121 can be set up as a microwave receiver for receiving data via a microwave channel 10, and a third transceiver device 121 can be set up as a bidirectionally operating infrared transceiver for receiving and sending data via an infrared channel 10.

The communication control device 100 also comprises a computing unit 130 and a storage device 140. The computing unit 130 is connected to the communication module 120 and the storage device 140 in such a way that data can be transmitted between the computing unit 130 and the communication module 120 and can be stored on the storage device 140 and/or can be read therefrom.

In the present exemplary embodiment shown, the storage device 140 is designed as an element separated from the computing unit 130, for example as a separate storage module. Therefore, it is easily possible to produce a communication control device 100 in different configurations, which are adapted to different requirements by a differently designed storage device 140, for example by a different storage capacity and/or transfer rate.

Alternatively, the storage device 140 can also be designed as a sub-element of the computing unit 130. Therefore, a higher transfer rate can be achieved for reading and writing data onto the storage device 140.

Data received by the communication module 120 via a channel 10 is transmitted to the computing unit 130. According to the invention, the computing unit 130, preferably by means of a computing program implemented thereon, is set up to determine the maximum allowable delivery latency (and thus also the priority for transmitting to further components 200, 300 in the vehicle 1) of such received data. In other words: the computing unit 130 sorts this data into an order, in which it is to be transmitted to the head unit 200, and in such a way that the temporal requirements are fulfilled in relation to the display and/or processing of all of this data.

Data that is not to be directly transmitted (i.e., with highest priority) to the head unit 200 is cached in the storage device 140 and only read therefrom and transmitted when the transmission of higher priority data has been completed. After the data has been transmitted, it can be deleted from the storage device 140 again, in order to create space for subsequently cached data.

In this manner, all of the time requirements in relation to the data of a channel 10 can be complied with, even if the data transmission path 201 only has a low transfer rate between the communication control device 100 and the head unit 200. In particular, this data transmission path 201 can have a much lower transfer rate than would be necessary for transmitting all of the data received from a channel 10 in the order of its receipt by the communication module 120 (i.e., without sorting and caching according to its temporal priority).

In other words, the performance requirements on the data transmission path 201 can be eased by buffering the data transmitted by a data transmission device 2 in bursts at a high transmission rate, but in a small packet size and in sufficient time (relative to the burst duration or effective occupancy time of the channel 10), in the storage device 140 of the communication control unit 100 and transmitting said data to the head unit 200 prioritized according to its latency requirements.

In one embodiment, the data transmission path 201 is formed between the head unit 200 and the communication control device 100 by simple and cost-effective controller area network (CAN) gateways 210, 110 connected to each other. Therefore, in an advantageous manner, it is not necessary to use gateways with a higher transmission rate, for example CAN flexible data rate (CAN-FD) gateways. Similarly, it is not necessary to provide additional or other alternative interfaces, for example Universal Serial Bus (USB) interfaces between the communication control device 100 and the head unit 200. Therefore, a simpler and more cost-effective design of both the communication control device 100 and of the head unit 200 is possible. The design and assembly of cables or cable sets for connecting the communication control device 100 and the head unit 200 can also be simplified. Additionally, this simplified design also reduces the risk of failure of the data transmission path 201.

In an analogous manner, power requirements for the further transmission of data, which has been received originally by a channel 10 and transmitted to the head unit 200, is eased for components of the vehicle electronics 300. Thus, the data transmission path 202 between the vehicle electronics 300 and the head unit 200 can also be formed by cost-effective simple CAN gateways 310, 220. More complex, more expensive and more failure-prone CAN-FD gateways or USB interfaces can be omitted here as well.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-7. (canceled)

8. A method comprising:
receiving, by a communication control device, data packets transmitted by at least one stationary data transmission device via at least one channel, wherein the communication control device receives the data packets via a communication module in a vehicle;
storing, by the communication control device, the data packets in a storage device;
determining, each data packet, an allowable delivery latency; and
transmitting, by the communication control device to at least one further component of the vehicle via at least one data transmission path, the data packets in an order, wherein the at least one data transmission path has a transmission rate that is less than a maximum transmission rate of the at least one channel,
wherein the order for transmission of the data packets is determined such that the allowable delivery latency of each data packet is adhered to.

9. The method of claim 8, wherein the data packets transmitted via the at least one data transmission path at least partially comprises toll payment information.

10. The method of claim 8, wherein the data packets transmitted via the at least one data transmission path at least partially comprises at least one urgent warning message.

11. A communication control device for a vehicle, the communication control device comprising:
a communication module having a transceiver configured to receive data packets from a stationary data transmission device via at least one channel;
a storage device configured to cache the data packets;
a computing unit; and
at least one gateway connected to a data transmission path having a transmission rate that is less than a maximum transmission rate of the at least one channel,
wherein the communication control device is configured to
receive the data packets transmitted by at least one stationary data transmission device via the at least one channel, wherein the communication control device receives the data packets via the communication module in a vehicle;
storing the data packets in a storage device;
determining, each data packet, an allowable delivery latency; and
transmitting, to at least one further component of the vehicle via at least one data transmission path, the data packets in an order,
wherein the order for transmission of the data packets is determined such that the allowable delivery latency of each data packet is adhered to.

12. The communication control device of claim 11, wherein the at least one gateway is a controller area network (CAN) gateway having a transmission rate that is lower than the maximum transmission rate of the at least one channel.

13. An arrangement of components in a vehicle, the arrangement of components comprising:
a communication control device; and
at least one further component connected to the communication control device via a data transmission path,
wherein the communication control device comprises
a communication module having a transceiver configured to receive data packets from a stationary data transmission device via at least one channel;
a storage device configured to cache the data packets;
a computing unit; and
at least one gateway connected to a data transmission path having a transmission rate that is less than a maximum transmission rate of the at least one channel,
wherein the communication control device is configured to
receive the data packets transmitted by at least one stationary data transmission device via the at least one channel, wherein the communication control device receives the data packets via the communication module in a vehicle;
storing the data packets in a storage device;
determining, each data packet, an allowable delivery latency; and
transmitting, to at least one further component of the vehicle via at least one data transmission path, the data packets in an order,
wherein the order for transmission of the data packets is determined such that the allowable delivery latency of each data packet is adhered to.

14. The arrangement of claim 13, wherein the at least one further component is an infotainment main unit configured to determine a route for the vehicle.
